(19) United States
(12) Patent Application Publication
(10) Pub. No.: US 2012/0214138 A1
(43) Pub. Date: Aug. 23, 2012

(54) AIRCRAFT SIMULATING APPARATUS

(75) Inventor: Peter Mayr, Munchen (DE)

(73) Assignee: INFOCOPTER GMBH, Munchen (DE)

(21) Appl. No.: 13/366,878

(22) Filed: Feb. 6, 2012

(30) Foreign Application Priority Data
Feb. 21, 2011 (EP) 11001426.3

(51) Int. Cl. G09B 9/08

(52) U.S. Cl. 434/37

(57) ABSTRACT

The present invention provides an aircraft simulating apparatus having an optical projection apparatus with a light beam source (11) and a projection screen (13); and a cabin (20), which includes in its interior a seat (21) and a front window (22) located between the seat and a front part of the cabin. The projection screen is located inside the cabin to be visible from the seat through the front window. The aircraft simulating apparatus is characterized in that the cabin has an outer width (W) seen from the front side in the range from 800 mm to 4000 mm, preferably from 1500 mm to 2500 mm; and the front edge of the seat (21a) is spaced apart from the front centered portion (13a) of the projection screen being most remote of the seat by a distance (D) in the range from 1500 mm to 3000 mm, preferably 1700 mm to 2200 mm.

### FIELD OF THE INVENTION

The present invention relates to an aircraft simulating apparatus, in particular to means for simulating the visual impression as seen by a pilot steering an aircraft, which may specifically be a helicopter.

### RELATED ART

Most known aircraft simulating apparatuses are used for simulating planes. Typical planes have a cockpit window providing only a small viewing angle of the environment. Hence, a respective simulating apparatus can be equipped with backlight monitors for visualization of the environment.

Some aircraft such as helicopters or fighter jets have cockpit windows with large viewing angles. For simulating such aircraft, other means are required for displaying wide angle views through the cockpit window.

Most common concepts are based on projection apparatuses. For example, a light-beam source provided with a fish-eye lens can be used for projecting an image on a projection screen in front of a cockpit window. Such a projection apparatus is limited to opening angles of less than 170°. A viewing angle through the cockpit window depends on this opening angle and is limited to less than the opening angle, e.g., less than 60° in the restricted space of a helicopter fuselage. Light-beam sources provided with fish-eye lenses are expensive and respective aircraft simulating apparatuses typically use projection screens with large extensions. Even with such projection screens, viewing angles are typically limited to less than 100°. Moreover, such projection screens fit only into large cabins which are substantially larger than the aircraft to be simulated. Such large cabins require heavy machinery for simulation of movements and are unsuitable for transportation. Moreover, their outer visual impression substantially differs from the fuselage of the aircraft to be simulated.

Other approaches are based on using multiple light-beam sources for providing a larger viewing angle. Such systems are expensive and suffer from the light-beam sources being in sight from a normal viewing direction of a user sitting in the cockpit. Moreover, all these approaches require large screens and large cabins, which substantially differ from the fuselage of the aircraft to be simulated.

### SUMMARY OF THE INVENTION

An object of the present invention is to provide an aircraft simulation apparatus which is compact. Another object of the present invention is to provide an aircraft simulation apparatus which allows a wide horizontal and/or vertical view angle, such as typical for a fighter plane or a helicopter. Yet another object of the present invention is to provide an aircraft simulation apparatus which has an outer shape similar to an aircraft to be simulated.

In view of these objects, the present invention provides the aircraft simulating apparatus according to claim 1 and the aircraft simulating system according to claim 15. The dependent claims relate to further developments.

According to the present invention, the aircraft simulating apparatus comprises an optical projection apparatus with a light beam source and a projection screen.

Further comprised is a cabin, which includes in its interior a seat and a front window located between the seat and a front part of the cabin. The projection screen is located inside the cabin to be visible from the seat through the front window.

The cabin has an outer width in the range from 800 mm to 4000 mm, and the front edge of the seat is spaced apart from the front centered portion of the screen being most remote of the seat by a distance in the range from 1500 mm to 3000 mm.

This allows to provide an aircraft simulation apparatus which is compact. Moreover, with this configuration it is possible to provide an aircraft simulation apparatus which allows a wide horizontal and/or vertical view angle. Further, with this configuration it is possible to provide an aircraft simulation apparatus which has an outer shape similar to an aircraft to be simulated. Other objects and advantages will become apparent from the subsequent description, the claims and the Figures.

### BRIEF DESCRIPTION OF THE DRAWINGS

FIG. 1 illustrates a side sectional view of an embodiment of an aircraft simulating apparatus according to the present invention.

FIG. 2 illustrates a top sectional view of the embodiment of the aircraft simulating apparatus according to the present invention.

FIG. 3 illustrates an embodiment of an aircraft simulating system, comprising an aircraft simulating apparatus.

### DETAILED DESCRIPTION OF EMBODIMENTS

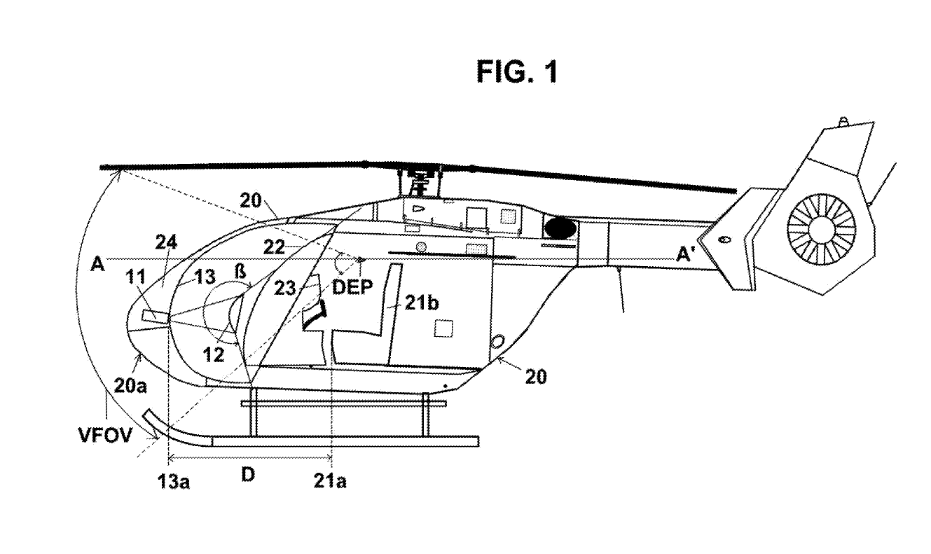

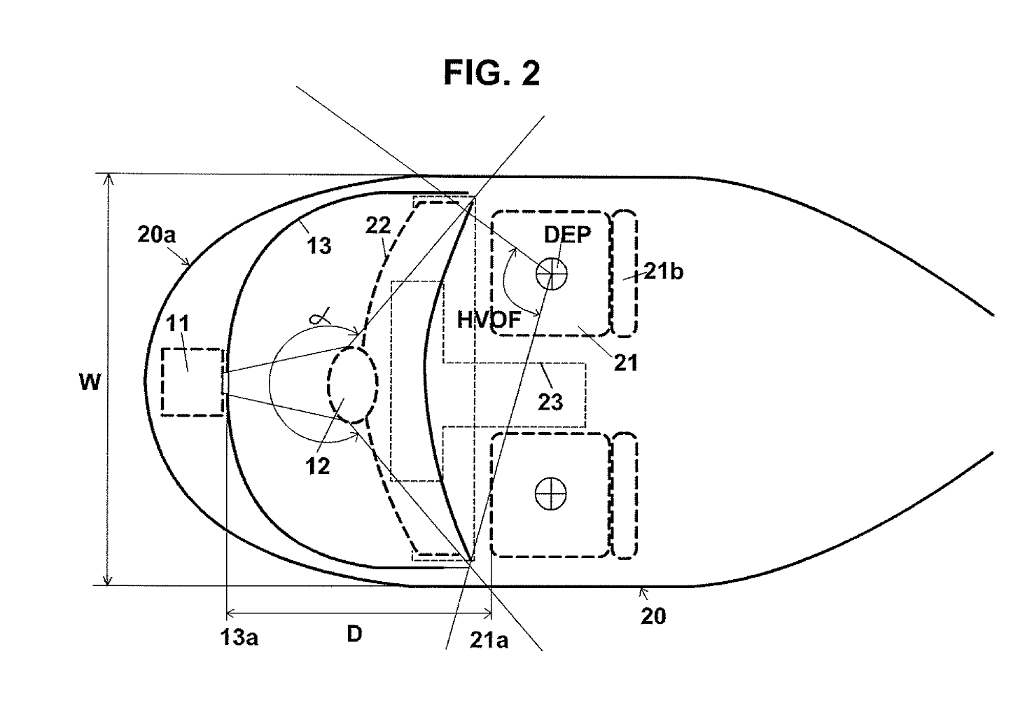

In the following, an aircraft simulating apparatus will be described with reference to FIGS. 1 and 2.

FIG. 1 illustrates a side sectional view of an embodiment of an aircraft simulating apparatus according to the present invention. As shown therein, the aircraft simulating apparatus comprises an optical projection apparatus 11 and a cabin 20.

The cabin 20 may be formed of metal or any other robust material, which may be same or similar to materials used for forming aircraft fuselages. The cabin 20 forms a substantially closed environment in which undesired outside effects such as sound or light from external sources are reduced for a user located inside. The cabin 20 includes in its interior a seat 21 and a front window 22 located between the seat 21 and a front part of the cabin 20. The front window 22 simulates a cockpit window of an aircraft. The seat 21 specifies the position of the user in a position like a pilot.

The simulating apparatus has a designed eye point (DEP), which serves as a reference point for the user ergonomics, in particular all optical viewing systems, instruments, seat(s). The designed eye point DEP also serves as reference for the optical projection and view angles in horizontal and vertical sections, HFOV and VFOV, respectively. Also the image projection is optimized according to the designed eye point DEP. In FIGS. 1 and 2, the designed eye point DEP is located above the seat 21, in the center above the seating surface in front of the backrest 21b in a height corresponding to a typical head position of a sitting user, such as between 600 mm and 900 mm above the seating surface. The present invention is not limited to this exact position.

When operating the simulating apparatus, the user sits on the seat 21 and looks towards the front window 22 through which he can see an image which is projected onto a projection screen 13.

In FIG. 1, the viewing direction is towards the left. Further provided is an instrument panel 23 in front of the pilot. The instrument panel 23 is arranged below the level of the designed eye point DEP such that the center of the horizontal viewing range is not blocked. The projection screen 13 is located inside the cabin 20 to be visible from the seat 21 through the front window 22.

FIG. 2 illustrates a top sectional view of the embodiment of the aircraft simulating apparatus according to the present invention.

As shown therein, the present embodiment provides two seats in one row, for pilot and copilot. This is not limiting. For example, the first row may alternatively comprise only one seat, and the copilot is then seated one seat row behind.

The outer width W of the cabin 20 as seen from the front side is also indicated in the top view shown in FIG. 2. According to the present invention, the outer width W is in the range from 800 mm to 4000 mm, preferably from 1500 mm to 2500 mm. This allows the cabin 20 to embrace the projection screen 13 and the projection screen 13 to embrace a front window 22 for aircrafts with one or more seats in the front row in a compact manner.

Thereby, it is possible that the cabin 20 is shaped like the fuselage of the aircraft to be simulated, and specifically, the front part 20a of the cabin is shaped like an aerodynamically shaped nose of an aircraft fuselage. In the shown embodiment, the cabin 20 is shaped like the fuselage of a helicopter, and the front part 20a of the cabin is shaped like an aerodynamically shaped nose of a helicopter fuselage.

Between the front edge 21a of the seat and the front centered screen portion 13a being most remote from the seat 21, there is a distance D in the range from 1500 mm to 3000 mm, preferably from 1700 mm to 2200 mm.

Compared to the seat position in an aircraft or helicopter to be simulated, the seat position in the simulator cabin is shifted towards the back by about one meter or about one seat row. This shift allows to accommodate the optical projection apparatus with a light beam source 11, a mirror 12 and a projection screen 13 inside the cabin 20, while generating from the exterior as well as from the interior a general shape of a fuselage nose. In an alternative embodiment, the light beam source 11 may be held in front of the front of the cabin shaped as a fuselage nose. Then, a suitable entrance for the light beam is provided.

The light beam source 11 may be a projector such as a beamer which is also is used for projection onto flat screens. The image source can provide moving images which are calculated by an image controller such as a computer with simulation software. The moving images are used to simulate a viewing environment from the aircraft cabin.

In FIG. 1, the light beam source 11 is located at a front part 20a of the cabin and arranged to emit a light beam in a direction towards the inner of the cabin 20. It can be supported by a support means which is attached to the front part 20a of the cabin.

Moreover, it can be located in the interior of the cabin 20, between the inner side of the cabin wall and the projection screen 13 such that the light beam is passing through a hole in the projection screen 13.

During operation, the light beam source 11 produces heat which requires cooling. An air path 24 can be provided between the screen 13 and the inner side of the cabin wall. Through this air path 24, air can flow for effectively cooling the light beam source 11. The air flow can be effected by convection or by some means for blowing air. The air path 24 can have an entry port at a lower position of the cabin 20 and an exit port at an upper position of the cabin 20.

The light from the light beam source 11 is directed to a convex mirror 12, which is adapted to deflectively expand the light beam towards the projection screen 13.

The convex mirror 12 has a spherical shape with a polished surface. It can be made of aluminum or other highly reflective materials. The convex mirror 12 has a curvature radius in a range from 100 mm to 1000 mm, preferably from 200 mm to 800 mm, and more preferably from 250 mm to 350 mm.

The outer diameter of the convex mirror 12 is in a range from 100 to 800 mm, preferably from 200 mm to 600 mm, and more preferably from 350 mm to 450 mm. This diameter is adapted to the distance of the convex mirror 12 from the light beam source 11 as well as the beam spread of the light beam source 11. The selected diameters allow usage of a conventional beamer having a relatively large spread of the light beam. Moreover, they provide a high quality projection onto the projection screen 13 with high demands on the surface quality of the mirror.

The position of the light beam source 11 relative to the convex mirror 12, the spread of the light beam, the curvature radius, and the diameter of the convex mirror 12 are adapted such that the optical projection apparatus provides, with a single of the above described light beam source 11, on the exit side of the convex mirror 12, an horizontal expansion angle a of more than 180° and a vertical expansion angle β of more than 120°.

The optical projection apparatus providing the above large expansion angles with only one single light beam source 11 has reduced costs with respect to prior art solutions which use plural light beam sources for providing such expansion angles. Moreover, a single light beam source 11 can be positioned out of sight from the designed eyepoint DEP located above the center of the seating area of the seat 21 in front of the backrest 21b.

Due to the large expansion angles of the optical projection apparatus, the projection on the projection screen 13 can be distorted. The aircraft simulating apparatus further comprises an image processing means which is adapted process an image signal which is input to the light beam source 11 and compensates distortion of the optical projection on the projection screen 13 as seen from the designed eyepoint DEP. The image processing means can compensate different types of distortion, in particular pillow distortion.

Preferably, the projection screen 13 is shaped to cover the complete outer view angle through the front window 22 seen from the designed eyepoint DEP located above the center of the seating area of the seat 21 in front of the backrest 21b. This avoids that a user can see the borders of the projected image which would reduce an illusion effect of the virtual reality. Preferably, the outer view angle through the front window 22 corresponds to a realistic view of the aircraft to be simulated.

For covering large viewing angles, a large extension of the projection screen 13 from the front centered portion 13a of the screen towards the seat 21 is required. Using a spherical screen would drastically increase the screen diameter. Such screen would not fit into a small cabin 20.

As shown in FIG. 1, the projection screen 13 is shaped to have a curvature radius which is increasing from the nose side to the front window side. This allows providing a large view angle without increasing the size of the cabin 20.

Moreover, with such projection screen 13, the front part 20a of the cabin can be shaped like an aerodynamically shaped nose of an aircraft fuselage, in particular a helicopter fuselage.

For producing such aspherical shape, the projection screen 13 can be made of glass-fibre reinforced plastics (GRP), however, the present invention is not limited thereto.

With the above described combination of front window 22 and projection screen 13, the seat 21 can be arranged to allow a horizontal viewing angle (HFOV) of at least 90°, more preferably at least 135°, and even more preferably at least 180°. Said arrangement further allows a vertical viewing angle (VFOV) of at least 50°, preferably at least 75°, and more preferably at least 100°. Both HFOV and VFOV are determined from the designed eye point DEP. Both HFOV and VFOV are restricted by the dimensions of the front window 22. The VFOV can be further restricted by an instrument panel 23 located before the seat 21.

The instrument panel 23 allows preventing direct sight from the designed eye point DEP into the light beam source 11. This is difficult to realize if plural light beam sources are used.

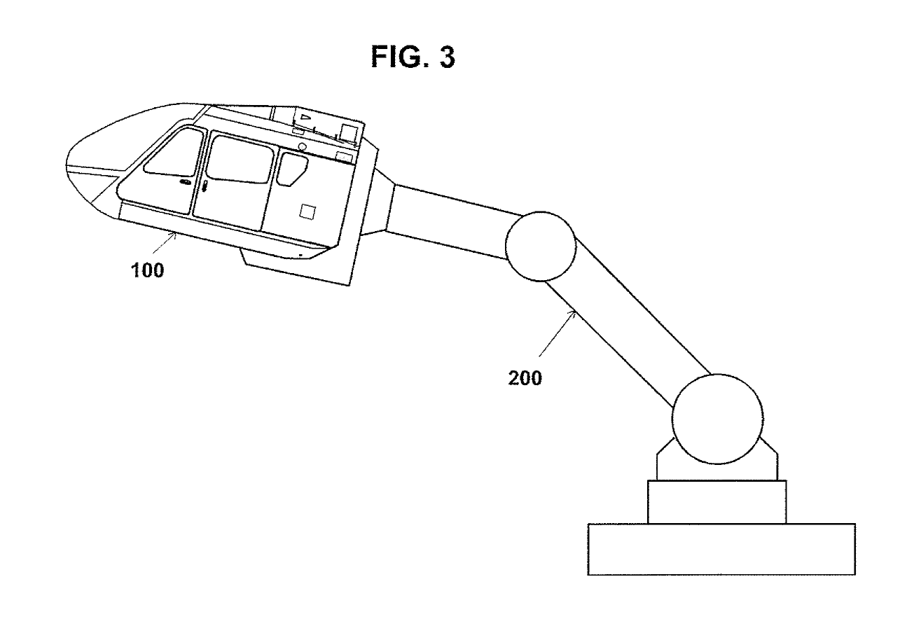

FIG. 3 illustrates an embodiment of an aircraft simulating system, comprising an aircraft simulating apparatus 100 attached to a holding means 200 such as a crane, which is capable of movably holding the simulating apparatus. In particular, the holding means 200 allows to execute movements so as to affect acceleration forces suitable for simulating forces during flight. Such configuration is possible due to the compact configuration of the simulating apparatus according to the present invention.

What is claimed is:

1. Aircraft simulating apparatus, comprising an optical projection apparatus with a light beam source (11) and a projection screen (13); and
a cabin (20), which includes in its interior a seat (21) and a front window (22) located between the seat and a front part of the cabin;
wherein the projection screen is located inside the cabin to be visible from the seat through the front window;
characterized in that the cabin has an outer width (W) seen from the front side in the range from 800 mm to 4000 mm, preferably from 1500 mm to 2500 mm; and the front edge of the seat (21a) is spaced apart from the front centered portion (13a) of the projection screen being most remote of the seat by a distance (D) in the range from 1500 mm to 3000 mm, preferably 1700 mm to 2200 mm.

2. Apparatus according to claim 1, wherein the light beam source is located at a front part of the cabin (20a) and arranged to emit a light beam in a direction towards the inner of the cabin (20) to a convex mirror (12), which is adapted to deflectively expand the light beam towards the projection screen (13).

3. Apparatus according to claim 2, wherein the optical projection apparatus has one single light beam source (11) and is adapted to provide, on the exit side of the convex mirror (12), an horizontal expansion angle (α) of more than 180° and a vertical expansion angle (β) of more than 120°.

4. Apparatus according to claim 2, wherein the convex mirror (12) has spherical shape with curvature radius in a range from 100 mm to 1000 mm, preferably from 200 mm to 800 mm, more preferably to 250 mm to 350 mm.

5. Apparatus according to claim 2, wherein the outer diameter of the convex mirror (12) is in a range from 100 to 800 mm, preferably from 200 mm to 600 mm, more preferably to 350 mm to 450 mm.

6. Apparatus according to claim 1, wherein the projection screen (13) is shaped to cover the complete outer view angle through the front window (22) seen from a designed eye point (DEP) located above the center of the seating area of the seat (21) in front of the backrest (21b).

7. Apparatus according to claim 1, wherein the projection screen (13) is shaped to have curvature radius increasing from the nose side to the front window side.

8. Apparatus according to claim 1, wherein the seat (21), front window (22) and projection screen (13) are arranged to allow a horizontal viewing angle (HFOV) of at least 90°, more preferably at least 135°, even more preferably at least 180°, as determined from the designed eye point (DEP).

9. Apparatus according to claim 1, wherein the seat (21), front window (22) and projection screen (13) are arranged to allow a vertical viewing angle (VFOV) of at least 50°, preferably at least 75°, more preferably at least 100° as determined from the designed eye point (DEP).

10. Apparatus according to claim 1, further comprising an instrument panel (23) located before the seat (21) and adapted to prevent direct sight from the designed eye point (DEP) into the light beam source (11).

11. Apparatus according to claim 1, further comprising image processing means adapted process an image signal input to the light beam source (11) to compensate distortion of the optical projection on the projection screen (13) as seen from the designed eye point (DEP).

12. Apparatus according to claim 1, wherein the light beam source (11) of the optical projection apparatus is located in the interior of the cabin (20), and an air path (24) for cooling the light beam source is provided between the screen (13) and the inner side of the cabin wall.

13. Apparatus according to claim 1, wherein the front part (20a) of the cabin is shaped like an aerodynamically shaped nose of an aircraft fuselage.

14. Apparatus according to claim 1, wherein the front part (20a) of the cabin is shaped like an aerodynamically shaped nose of a helicopter fuselage.

15. Aircraft simulating system, comprising the aircraft simulating apparatus (100) according to claim 1; and holding means (200) for movably holding the aircraft simulating apparatus.
